(19) United States
(12) Patent Application Publication
(10) Pub. No.: US 2025/0272571 A1
(43) Pub. Date: Aug. 28, 2025

(54) Method For Guiding Transfer Learning

(71) Applicants: Danko Nikolic, Frankfurt am Main (DE); Davor Andric, Dreieich (DE); Vjekoslav Nikolic, Zagreb (HR)

(72) Inventors: Danko Nikolic, Frankfurt am Main (DE); Davor Andric, Dreieich (DE); Vjekoslav Nikolic, Zagreb (HR)

(21) Appl. No.: 18/853,824

(22) PCT Filed: Dec. 11, 2023
(86) PCT No.: PCT/EP2023/085102

§ 371 Date: Oct. 3, 2024

Related U.S. Application Data
(60) Provisional application No. 63/432,119, filed on Dec. 13, 2022.

(51) Int. Cl. G06N 3/096

(52) U.S. Cl. CPC G06N 3/096

(57) ABSTRACT

A method is directed to guiding transfer learning (GTL) carried on a pre-trained learning model to solve a main training problem having a main training problem difficulty. Scout networks are created from the artificial neural network of the pre-trained learning model, each scout being assigned a scout problem with a scout problem difficulty much lesser than the main training difficulty. A guidance matrix comprising guidance values is created based on one measure of central tendency across all the weights and biases of the plurality of scout networks. The transfer learning of the pre-trained learning model on the main training problem is carried out by applying said guidance matrix to individually alter the process of updating the parameters of said artificial neural network while applying a gradient descent algorithm on the main training problem.

### RELATED APPLICATIONS

This application is a national stage of International Application No. PCT/EP2023/085102, filed Dec. 11, 2023, which claims the benefit of and priority to U.S. Provisional Patent Application No. 63/432,119, filed on Dec. 13, 2022, each of which is hereby incorporated by reference herein in its entirety.

### FIELD OF THE INVENTION

The present invention relates generally to methods of transfer learning and fine-tuning of machine learning models. More specifically, the invention relates to a method for guiding transfer learning; two machine learning devices for carrying out the method for guiding transfer learning; a guiding matrix; a trained model; two non-transitory computer-readable mediums storing thereon computer-executable instructions for each of the two machine learning devices; and a method of using the method for guiding transfer learning.

### Glossary of Terms Used in the Invention

Absolute values of a difference: The distance between two numbers.

Categories: Discrete values that are not in an ordered relationship. Examples include breeds of dogs, words, or postal codes. These features are known as “categorical”; each value being called a category. The number of categories trained in the main training problem is written as n(main).

Central tendencies: In statistics, a central tendency is a central or typical value for a probability distribution. The most common measures of central tendency are the arithmetic mean, the median, and the mode.

Data point: It is a minimal discrete unit of information used for training and testing machine learning models. For example, a single image (e.g., of a dog) together with a label indicating the category to which this image belongs “dog”, would be a single data point.

Number of model dimensions: The number of dimensions in a model tells us the number of directions along which variables change in the model. This number corresponds to the number of parameters that are allowed to change during the learning process.

Parameters: Weights and biases, denoted as w and, b, respectively, are the learnable parameters of the artificial neural networks.

Number of layer dimensions, alternatively called dimensionality of a layer. Analogous to the number of model dimensions, indicates the number of parameters allowed to change in a given layer of a model.

Error rate: Error rate refers to a measure of the degree of prediction error of a model made with respect to the true model. The term error rate is often applied in the context of classification models.

Local minimum, plural local minima: The local minimum is a point within an interval at which the function has a minimum value. In machine learning, this is a point at which the network does not learn anymore unless some change is made to the learning process.

Median: In statistics and probability theory, the median is the value separating the higher half from the lower half of a data sample, a population, or a probability distribution.

Overfit: In mathematical modeling, overfitting is the production of an analysis that corresponds too closely or exactly to a particular set of data, and may therefore fail to fit additional data or predict future observations reliably.

Model, alternatively called AI model, alternatively called learning model: Defined very broadly, the model is an algorithm that relies on training data to recognize patterns and make predictions and/or decisions without the intervention of humans. Models commonly include, but are not limited to, artificial neural networks.

Pre-trained model: A pre-trained model is a deep learning model that is trained on large datasets to solve a specific task/problem, and that can be used either as it is, or customized by further training to suit specific application requirements.

Pre-training: The process of creating a pre-trained model.

Fine-tuning: This is one way to leverage pre-trained models. Fine-tuning allows all the layers to be updated, not only the new layers.

Transfer learning: This is another way to leverage pre-trained models. Transfer learning freezes all the pre-trained layers and only trains the new layers.

Problem, alternatively called task, or learning task, or learning problem: The learning problem presented to a model in the form of a data set consisting of input and output values. The model needs to find an appropriate set of parameters such that it can accurately predict output values when given input values.

Main training problem: is the problem that is being solved during transfer learning or fine-tuning in the method for guiding transfer learning of the invention.

Difficulty of the problem: A difficulty of a learning problem in the method for guiding transfer learning of the invention, is expressed as error rate or loss; the higher the error rate or loss for a given learning problem, the higher the difficulty. One way to reduce learning difficulty is to reduce the total number of discrete values (n) into which the inputs need to be classified.

Related problems, alternatively called similar learning problems, are problems of similar nature to be solved using models, similarity referring to the input data and the output categories in the method for guiding transfer learning of the invention.

For example, if two models both learn to recognize written letters, the first model recognizes the letters A, B, and C, and the second model recognizes the letters D, E, and F, the two problems related to letter recognition are related. However, the problem of predicting whether it will rain the next day can be considered unrelated to the first and second problems.

Unrelated problems: the opposite of related problems, see “related problems” in the method for guiding transfer learning of the invention. An example of models solving unrelated problems would be learning to predict weather from information about wind, temperature, and pressure for the first model and learning to classify images into indoor and outdoor contents for the second model.

Primary dataset: The dataset available for training the model on the main training problem in the method for guiding transfer learning of the invention.

Guided transfer learning GTL: This is a novel machine learning method that makes the object of this invention, namely the method for guiding the transfer learning.

Scout network, abbreviated scout: A neural network model used in the method for guiding transfer learning of the invention.

Scouting information: Information about the degrees of changes in parameters—usually weights and biases that needed to be made for scouts to learn a new problem in the method for guiding transfer learning of the invention.

Scouting process: is a process of creating the plurality of scout networks in the method for guiding transfer learning of the invention.

Guidance matrix: A matrix of the same dimensions as the matrix containing parameters that the model is learning such as weights and biases. Each parameter that is being learned has its guidance value in the guidance matrix. Guidance matrices are used in the method for guiding transfer learning of the invention. An artificial neural network that consists of multiple layers will have multiple guidance matrices, one for each trainable layer.

Guiding parameter: A single value within a guidance matrix.

Small number of categories: The number of categories used to train a scout in the method for guiding transfer learning of the invention, written as nₖ(scout). The number of scout categories is small when nₖ(scout)<<n(main).

Less difficult problems: Problems that are easier to learn by the models as indicated by the performance of the network on the test data set and indicated by high accuracy and/or low loss. High accuracy is the same as low error rate.

Loss: In mathematical optimization and decision theory, a loss function or cost function is a function that maps an event or values of one or more variables onto a real number intuitively representing some “cost” associated with the event. An optimization problem seeks to minimize a loss function.

Model performance alternatively called performance: A model's performance is expressed as accuracy, i.e., error rate in terms of correctly classified inputs into categories and/or as loss on a test dataset.

Gradient: Change in the value of a parameter calculated by a gradient descent algorithm.

### BACKGROUND OF THE INVENTION

The problem of learning in artificial neural networks requires finding a specific set of values for connection weights and biases such that the network as a whole accurately performs a required task [1](LeCun et al. 1998). Finding the right set of values for these parameters is often not an easy task, especially when the networks become large and the tasks become ambitious.

The main reason for the difficulties in learning is that the space of possibilities, the so-called parameters space, tends to be huge, especially in artificial neural networks with many layers known as deep learning, which may have millions or even billions of parameters. This means that the entire space can never be explored to find the most optimal set of parameters. Rather, only a small fraction of possible values can be evaluated. Hence, the learning algorithms rely on making small informed steps toward a possible solution. The algorithms search for ‘hints’ on the direction in which the values in the parameters space should be changed. Then this new state is evaluated, and new ‘hints’ are calculated, and so on. These hints are calculated based on the training data. At each iteration, a question is asked: What do training data suggest? In which direction is the best to move the weights and biases to find a solution? This learning method is known as gradient descent and is the most popular approach for training deep learning networks.

One of the main disadvantages of the known learning methods is that the deep learning models present unsustainable demands on resources: parameters and training data sets. The most advanced deep learning models require too large numbers parameters and large training data sets, making such neural networks not affordable for everyone. Instead, only well-endowed institutions can afford to develop such models. This problem is well substantiated by a study carried out in 2020 by Kaplan et al. [2] on how the demands on language models grow. They have shown that an increase in the amount of data helps until one point where it does not help anymore unless the model size is increased (i.e., the number of parameters is increased); then subsequent increases in model sizes keep improving the performance but only up to a point where again an increase in the data size is needed to accompany the increase in the model size and so on. Apparently, there is no limit in intelligence that these models can reach, provided that both the amount of data and the model sizes continue increasing. A later study has reported that one can trade off data size and model size to a degree: A somewhat smaller model can be trained by disproportionally increasing the amount of data, according to a study made in 2022 by Hoffmann et al. [3].

The conclusion to be drawn from the Hoffmann et al. [3] study is that the price paid for this apparently unlimited increase in intelligence increase is so high that the entire endeavor becomes unsustainable. This is because, as Kaplan et al. [2] found, demands on resources grow with a power law. This means that the sizes of the models explode and so do the needed amounts of data: To double the intelligence of a model i.e., to reduce the loss by half, one needs a lot more than double the amount of resources, which explains why the language models today are so large, and only the institutions with deep pockets can afford to build them.

In theory, it is possible that much smaller deep learning models exist—“much smaller” defined in terms of parameters and training data sets, being able to perform exactly the same tasks as the large ones. However, in reality, the much smaller deep learning models have the inconvenience of the inability of the learning algorithms to find the parameter values for such much smaller deep learning models.

One known example is the n-parity problem also known as generalized XOR problem, which can be implemented by small neural networks. However, these small networks have to be either constructed by hand—see Nikolić study of 2022 [4], or learned by specialized learning algorithms designed specifically for that problem—see Schmidhuber & Hochreiter 1996 [5]; Linial, Mansour & Nisan 1993 [6]; Mansour 1994 [7]. These specialized learning algorithms do not rely on gradient descent and hence, can learn only a handful of other functions besides that one. In contrast, gradient descent algorithms can train neural networks to perform a variety of tasks, including many real-life tasks. Gradient descent can also learn to solve n-parity problems, but the amount of required resources—parameters and training data sets, explodes.

Using the gradient descent—despite its advantage mentioned above, has two disadvantages:
(i) high likelihood of local minima when the number of parameters is small, and
(ii) overfitting the training data, when the number of parameters is increased in order to overcome local minima.

A subsequent increase in data amount is then needed to overcome the overfit, which is explained here. The inventors think that the way gradient descent works around these problems is highly inefficient because it requires an increase in the number of parameters together with the amount of data. By a sheer increase in the number of dimensions (parameters), it becomes less likely that the model will end up in a local minimum. However, this is inefficient because using more parameters makes it more likely to overfit by poorly generalizing i.e., by choosing too easy paths downhill the descent. Consequently, the increase in parameters needs to be matched with a corresponding increase in the amount of training data.

The origin of these disadvantages is related to how gradient descent algorithms work in the state of the art, and are explained next.

Gradient descent algorithms work on a step-by-step basis. In machine learning a step also called an epoch, is when all the training data is used at once. After each epoch, all the parameters are updated and the machine learning model starts the whole process again for the next update—that is, for the next epoch.

Making an analogy with the situation of a person, said person can see only one step at a time, namely the upcoming step. The person must decide on the direction of the next step, based on what the person sees after having walked the preceding step. The expression “what the person sees” encompasses, say for the sake of the argument, information such as the presence of obstacles on the floor. The presence or absence of obstacles are pieces of information available for the next step only after the previous step has been completed, for example if the person is walking in a dense fog. Therefore, by repeating such “short-sighted” steps, the person may end up at a dead end—resulting in a local minimum, and may have to walk back and make a different choice at some earlier place.

Much like a person walking in a fog, the gradient descent algorithm does not have access to all the needed information necessary for making better decisions at earlier steps—which causes the first disadvantage of the high likelihood of local minima when the number of parameters is small. This problem can be solved by adding more dimensions/parameters, which effectively opens new possibilities to walk around obstacles. Notably, a person is walking in a 2D space, whereas a gradient descent is moving in a multi-dimensional space. This solves the aforementioned dead-end problem of local minima but then creates a new problem: the gradient descent has too many choices and may easily end up at some random place—a place where it is not performing well on new data-which is the second disadvantage of overfitting the training data. To solve this second disadvantage, the gradient descent algorithm needs an increase in the amount of training data. The additional data present additional obstacles so that the number of choices reduces again.

While increasing the number of dimensions and the amount of data, the state-of-art approaches do not increase the capability of the gradient descent to know what will happen several epochs ahead; each decision on the updates of parameters can solely be made based on information available at a given epoch. There is no known algorithm capable of providing information about future epochs.

### SUMMARY OF THE INVENTION

An exemplary problem to be solved by invention is called here the “objective” of the invention in order to avoid confusion with the term “problem” in the context of machine learning.

The objective of the invention is to find a method for learning by providing the gradient descent algorithms with early information that would normally only be accessible later during the training process and only when using large amounts of data. This way, the gradient descent algorithm can make good decisions about parameter updates even when learning from small amounts of data.

In particular, the objective of the invention is: i) to reduce the likelihood of being stuck in local minima, and ii) to reduce the risk of overfitting the training data.

In a first aspect of the invention, it is claimed a method for guiding transfer learning carried on a pre-trained learning model to be trained on a primary dataset to solve a main training problem. The main training problem having a main training problem difficulty d(main). The pre-trained learning model is an artificial neural network having a plurality of parameters, namely weights w_{Pj} and biases b_{Po}.

The method comprises the following steps:
S1 receiving the pre-trained learning model by a first machine learning device;
creating a plurality of scout networks K from the artificial neural network, each scout network k having its plurality of parameters—weights wⱼₖ and biases bₒₖ,
wherein for each parameter w_{Pj}, b_{Po} in the pre-trained learning model, there is a corresponding parameter wⱼₖ, bₒₖ in each scout network k,
assigning to each corresponding parameter (wⱼₖ, bₒₖ) of each scout network k a corresponding scout training problem, each scout training problem having a corresponding scout training problem difficulty, where each scout training problem difficulty dₖ(scout) is much lesser than the main training problem difficulty d(main):

dₖ(scout)<<d(main)
wherein
the main training problem difficulty d(main) and each scout training problem difficulty dₖ(scout) are measured in terms of error rate and/or loss on a test dataset, said measures being reached after training of the pre-trained learning model,
S2 generating, by the first machine learning device, a guidance matrix comprising guidance values, where the guidance values are calculated based on one measure of central tendency of differences between every weight wⱼₖ and bias bₒₖ of the plurality of scout networks K, and the corresponding weight w_{Pj} and bias b_{Po}, of the pre-trained learning model, respectively, and sending the guidance matrix to a second machine learning device together with the pre-trained model;
S3 receiving by the second machine learning device of the guidance matrix and of pre-trained model from the first machine learning device and, simultaneously, receiving the primary dataset;
guiding, by the second machine learning device, the transfer learning of the pre-trained learning model on the main training problem by applying said guidance matrix to individually alter the process of updating the parameters of said artificial neural network while applying a gradient descent algorithm on the main training problem;
generating a trained model for making it available for use.

In a second aspect of the invention it is claimed a first machine learning device having at least one first processor, at least one first memory, and a first non-transitory computer-readable medium storing first computer-executable instructions.

The first machine learning device is communicatively coupled to a second machine learning device.

When said first computer-executable instructions are executed by the first machine learning device, the first machine learning device is configured to receive a pre-trained model, to carry out steps 1 and 2 of the method, generating a guidance matrix comprising guidance values, and to send the guidance matrix to the second machine learning device.

In a third aspect of the invention it is claimed a second machine learning device having at least one second processor, at least second memory and a second non-transitory computer-readable medium storing second computer-executable instructions thereon.

The second machine learning device is communicatively coupled to the first machine learning device.

When said second computer-executable instructions are executed by the second machine learning device, the second machine learning device is configured to receive the pre-trained model and the guidance matrix comprising guidance values from the first machine learning device, and to carry out step 3 of the method, generating a trained model for making it available for use.

In a fourth aspect of the invention it is claimed a guidance matrix comprising guidance values, generated by the first machine learning device, according to step 1 and 2 of the method 5 of any of its embodiments.

In a fifth aspect of the invention it is claimed a trained model generated by the second machine learning device, according to step 3 of the method of any of its embodiments.

In a sixth aspect of the invention it is claimed a first non-transitory computer-readable medium storing thereon first computer-executable instructions which, when executed by the first machine learning device, cause the first machine learning device to carry out the steps 1 and 2 of the method of any of claims 1 to 3, and storing on the first non-transitory computer-readable medium the pre-trained learning model and the generated guidance matrix of claim 7.

In a seventh medium storing thereon second computer-executable instructions which, when executed by the second machine learning device, cause the second machine learning device to carry out the step 3 of the method of any of the claims 1 to 3, and storing on the second non-transitory computer-readable medium the trained model of claim 8.

In an eighth aspect of the invention it is claimed a method of use of the method for guiding transfer learning of any of its embodiments, suitable for the Advanced Driver Assistance Systems ADAS of a vehicle, wherein the second machine learning device is included in an Electronic Control Unit ECU of the vehicle, and wherein the trained model outputted by the second machine learning device is used to improve prediction of traffic events during driving.

The invention has the advantage of improving the self-capacity to learn of the learning model, in particular the trained model has improved capacities of providing the gradient descent algorithms with early information that would normally only be accessible later during the training process and only when using large amounts of data, enabling the gradient descent algorithm to make good decisions about parameter updates even when learning from small amounts of data. In particular, by using the invention, the likelihood of being stuck in local minima is reduced and the risk of overfitting the training data is also reduced in comparison with prior art methods.

### BRIEF DESCRIPTION OF THE DRAWINGS

FIG. 1 shows the general case according to the invention when the first machine learning device and the second machine learning device are different devices

FIG. 2 shows an embodiment of the invention when the first machine learning device and the second machine learning device are physically and mechanically coupled.

FIG. 3A shows an example of selecting parts of a data set to train scouts.

FIG. 3B shows an intermediary step for calculating the guiding matrix in step 2.

FIG. 3C shows an example of four guiding matrices for a deep learning model with four layers as outcome of step 2. The plots show how the values of guiding parameters are distributed.

FIG. 4 shows an example of a use of the method of guiding transfer learning of the invention.

### DETAILED DESCRIPTION

The basic principle behind the invention is explained using analogy with human scout activities.

Boy and girl scouts participate in exploring activities as part of their educational programs. They are sent by their teachers in the field—i.e. in the woods, to carry out some simple tasks. For example, from a large group of scouts, a small part is sent to check if there are small wild animals trapped while another part is sent to check whether there is a veterinary in the nearby village. Then the scouts report to the teacher and the problem of the wild animals is solved with their help.

Military scouts are soldiers sent out ahead of a main force as to gather information about the enemy's position, strength, or movements, the gathering of the information being scouts' tasks.

The first aspect of the invention deals with a method for guiding transfer learning carried on a pre-trained learning model to be trained on a primary dataset to solve a main training problem. The main training problem has a main training problem difficulty d(main). The pre-trained learning model is an artificial neural network having a plurality of parameters, namely weights W_{Pj} and biases b_{Po}.

The artificial neural network is an example of the machine learning algorithm. It is used in the invention to which the method for guiding transfer learning GTL can be applied. The skilled person shall understand that the teaching of the invention exemplified for the artificial neural network shall apply mutatis mutandis to other machine learning algorithms.

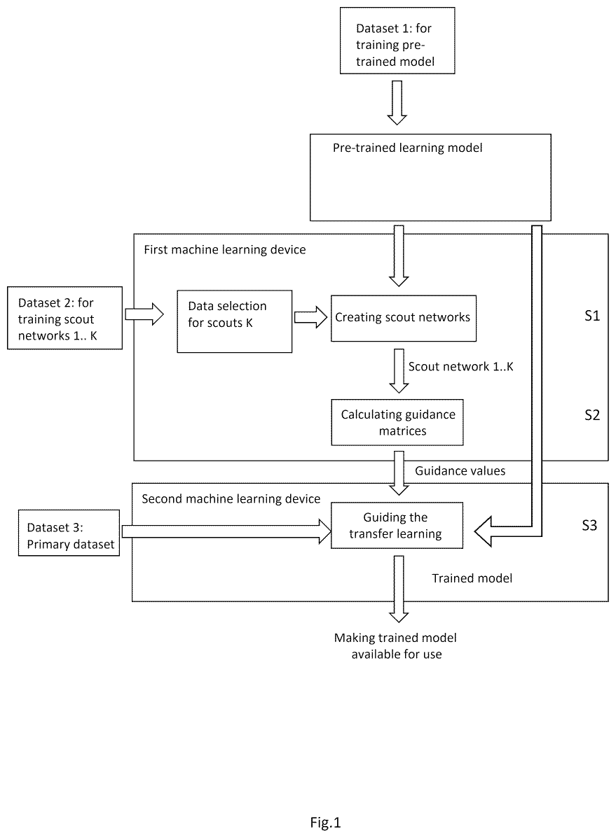

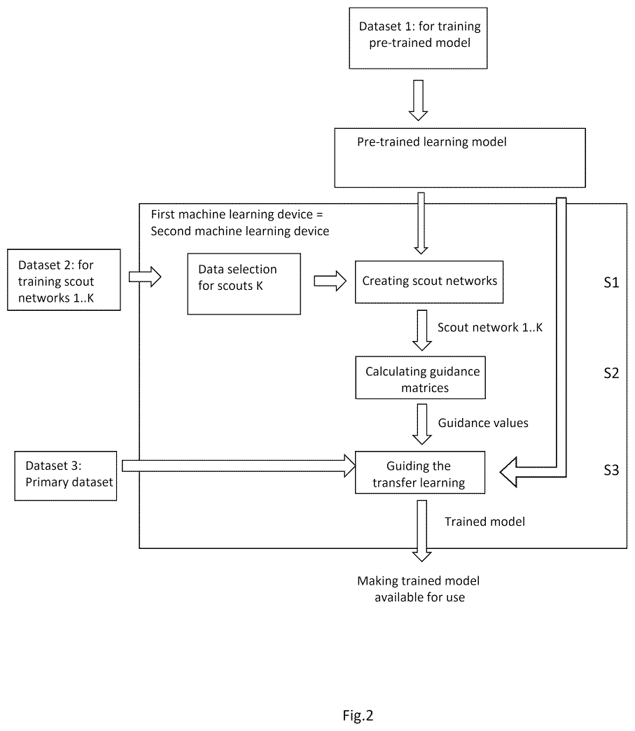

The pre-trained model is according to prior art, being received from an external datasets source. The dataset on which the pre-trained model is pre-trained—called dataset 1 in FIG. 1 and FIG. 2, as well as the creation of the pre-trained model, are outside the scope of the invention.

The method for guiding transfer learning of the invention has three steps.

The first step of the method, with reference to FIG. 1 and FIG. 2, has three sub-steps:

In the first sub-step of step 1, a first machine learning device receives the pre-trained learning model.

In the second sub-step of step 1, the first machine learning device creates a plurality of scout networks K from the artificial neural network, each scout network k having its plurality of parameters—weights wⱼₖ and biases bₒₖ. For each parameter (w_{Pj}, b_{Po}) in the pre-trained learning model, there is a corresponding parameter (wₖ, bₖ) in each scout network k.

In the third sub-step of step 1, the first machine learning device trains the scout networks K, by assigning to each corresponding parameter (wⱼₖ, bₒₖ) of each scout network k a corresponding scout training problem, each scout training problem having a corresponding scout training problem difficulty, where each scout training problem difficulty dₖ(scout) is much lesser than the main training problem difficulty d(main):

$${d}_{k} ( scout ) << d ( main ) \qquad [ Eq . 1 ]$$

Both the main training problem difficulty d(main) and each scout training problem difficulty dₖ(scout) are measured in terms of error rate and/or loss on a test dataset, said measures being reached after training of the pre-trained learning model.

The creation of the scout networks K is called “scouting” in this invention.

The role of the scout networks K is to search through the space of the parameters of the artificial neural network, that is the weights w_{Pj} and biases b_{Po} of said artificial neural network to explore “what lays behind”. Scouting has the role to find out what is expected to be encountered in the ‘future’—that is in step 2 of the method, in a similar way with military scouts sent out ahead of a main force that gather information about the enemy's position, strength, or movements. More precisely, scouting finds out which parameters are likely to lead the training process to a local minimum or to overfit and which ones are not likely to lead to said local minimum or to overfit.

Thus, the scout networks K are configured to solve much less difficult problems than the neural network from which they were created. What makes a problem easy or difficult is the amount of data needed and the number of parameters needed to reach a selected level of performance.

The dataset on which the scout networks K are trained on the main training problem called dataset 2 in FIG. 1 and FIG. 2, is received from an external source, and is outside the scope of the invention, as well as the relationship between dataset 1 and dataset 2.

When the dataset 2 is received by the first machine learning device, a selection of its data is carried out for the purpose of training the scout networks K, namely for the purpose of assigning the scout training problems.

One of the preferred ways to express the main training problem difficulty d(main) and the scout problem difficulty dₖ(scout) is by using the notion of “categories”.

In this preferred embodiment, the method for guiding transfer learning is carried out by the machine learning device on said pre-trained learning model to be trained on said primary dataset to solve the main training problem, whose difficulty is expressed as a number of n(main) training categories of the main training problem. Each scout training problem difficulty is expressed as a number of nₖ(scout) training categories of the corresponding scout training problem.

The pre-trained learning model uses the artificial neural network, having the plurality of parameters—the weights w_{Pj} and the biases b_{Po},

In the first sub-step of step 1 of this preferred embodiment, the first machine learning device receives the pre-trained learning model.

In the second sub-step of step 1 of this preferred embodiment, the plurality of scout networks K is created from the artificial neural network, each scout network k having its plurality of parameters—the weights wₖ and the biases bₖ, where for each parameter w_{Pj}, b_{Po} in the pre-trained learning model, there is a corresponding parameter wₖ, bₖ in each scout network k.

Once the scout networks K created, for each scout network k, a corresponding scout problem is assigned in the third sub-step of step 1 of this preferred embodiment. The scout problem difficulty is expressed as a number of nₖ(scout) training categories, where the number of categories of each scout problem nₖ(Scout) of is much less than the number of categories of the main training problem n(main):

$${n}_{k} ( scout ) << n ( main ) \qquad [ Eq . 2 ]$$

where the number of n(main) categories and the number of nₖ(Scout) categories are measured in terms of error rate and/or loss on a test dataset, said measures being reached after training of the pre-trained learning model.

This means that, in this preferred embodiment, a reduction in difficulty, and, thus, an increase in performance expressed in terms of lower error rate and/or loss, is achieved by making the number of nₖ(Scout) categories much smaller compared to the number of n(main) categories.

The number of categories used to train a scout nₖ(Scout) needs to be much smaller than the number of categories trained in the main training problem, n(main), as this makes the problem easier, as one feature of the invention is making the problems for the scouts K easier than the main training problem.

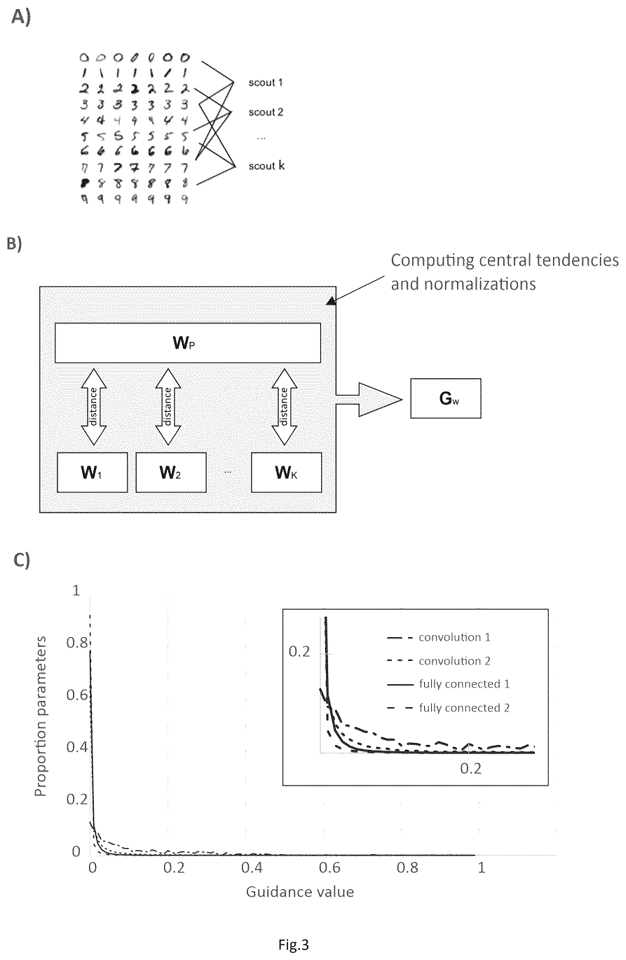

So, for example, a 10-category main training problem can be broken into multiple 3-category scout problems—see FIG. 3A, each scout problem achieving better performance than the 10-category main training problem.

Fewer categories and more data points have the advantage of reducing the chances of hitting a local minimum.

Expressing the main training problem difficulty and the scout problem difficulty by using the notion of “categories” is advantageous because the “categories” are meaningful in many technical fields where the method of the invention can be used.

The main training problem difficulty can also be expressed in other ways including training data that are not organized into categories, such is the case with autoencoders. In this case, a more direct measure of task difficulty can be measured in terms of loss on a test or training dataset.

The nₖ(scout) categories can be either non-overlapping or partially overlapping.

In the second step of the method, with reference to FIG. 1 and FIG. 2, and FIG. 3B, the first machine learning device generates a guidance matrix comprising guidance values, where the guidance values are calculated based on one measure of central tendency of differences between every weight wⱼₖ and bias bₒₖ of the plurality of scout networks K, and the corresponding weight w_{Pj} and bias b_{Po} of the pre-trained learning model, respectively. Then, the first machine learning device sends the guidance matrix to a second machine learning device together with the pre-trained model.

The guiding matrix created in step 2 of the invention reflects information from all the scouts K by giving low learning preference with guiding values close to zero, to the parameters likely to lead to problems,—i.e. local minimum or overfitting, and high preference to the parameters likely to improve the performance of the model, guiding values much larger than zero, in a similar way with military scouts sent out ahead of a main force to gather information about the enemy's position, strength, or movements, based on which the superiors create a plan on along which routes to move the main forces.

Exemplification of the calculation is presented below for the guidance matrix, called G.

The skilled person shall understand that the term “guidance matrix”—used for the ease of understanding of the teaching of the invention, shall refer to a plurality of matrices, including multi-dimensional matrices called tensors. The calculation and the use of one guidance matrix as exemplified in the invention shall be repeated for all the guidance matrices of each real-life situation where the invention is used.

For the sake of easy understanding, the exemplification is presented for a single layer of the pre-trained model, being known by the skilled person that said pre-trained model has a multitude of layers.

All scouts K start learning from the same pre-trained learning model with the plurality of parameters—weights w_{Pj} and biases b_{Po}. From that point on, the parameters weights wₖ, and biases bₖ—of each scout network k are learned after some learning criterion, such as for example a fixed number of epochs, said learning criterion being outside the scope of the invention.

Let us denote the parameters for each scout k as wₗₖ . . . wⱼₖ, and bₗₖ . . . bₒₖ,
where jϵ{1 . . . J}, and J is the number of weights, and m ϵ{1 . . . M} and M is the number of biases and k is ϵ{1 . . . K} and K is the number of scouts—see FIG. 3B.

All the parameters wₜₖ . . . wⱼₖ, and, respectively, bₗₖ . . . bₒₖ for each scout network k are organized into a respective tensor, which can be one-dimensional i.e., a vector, two-dimensional, i.e. a matrix, or have even more dimensions. We note these tensors as W and B.

Further on, it is exemplified the calculation of the guidance matrix G obtained from the matrices of the weights wₗₖ . . . wⱼₖ, hereafter abbreviated as “Wₖ's”. All the computations shown for the w's are equivalently performed for the biases bₗₖ . . . bₒₖ, abbreviated as “Bₖ's”.

Then, the guidance matrix Gw is computed from Wₖ's and W_{B}, the guidance matrix G having the same dimensionality as Wₖ's, which is also the same as W_{B}.

There are multiple ways to compute G. The simplest way to obtain the guidance values in the guidance matrix is to first calculate the average squared distance Mw, across all Wₖ's from W_{B}, as exemplified below. Another way to obtain the guidance values in the guidance matrix—not exemplified is to use the average of the absolute values of the distances instead of the average squared distance. This is why FIG. 3B uses the term “distance”: to encompass various possible formulas.

The average squared distance between every weight wⱼₖ is denoted as mⱼ and is computed as follows:

$${m}_{j} = 1 / n \sum {( {w}_{{B}_{j}} - {w}_{j} k )}^{2} \qquad [ Eq . 3 ]$$

In a matrix form, mean deviation values for the weights and biases are denoted as MW and Mb, respectively.

Then, the average squared distances are normalized in order to obtain the matrix G. The formula used for normalization will determine how strongly will the guidance matrix G affect the learning in step 3 of the method.

One non-limiting example of normalization is to set all the values within G to be limited between 0 and 1. This can be done with the following equation:

$$G = ( M - min ( M ) ) / ( max ( M ) - min ( M ) ) , \qquad [ Eq . 4 ]$$

where min(M) and max(M) are scalars representing the minimum and maximum values in M, respectively. Other types of normalization are possible.

In some preferred embodiments, the calculation of the central tendency of step 2 is based on one measure of central tendency selected from the list below:
(i) the mean of squared differences across the weights wⱼₖ and biases bₒₖ, and w_{Pj}, b_{Po} respectively,
(ii) the mean absolute values of differences across the weights wⱼₖ and biases bₒₖ, and w_{Pj}, b_{Po} respectively,
(iii) the median value of the squared differences or the absolute values of differences across the weights wⱼₖ and biases bₒₖ, and w_{Pj}, b_{Po} respectively, the mode value for the squared differences or the absolute values of differences across the weights wⱼₖ and biases bₒₖ, and w_{Pj}, b_{Po} respectively.

Generally, the choice of the measure of central tendency depends on the types of distributions—e.g., symmetric vs skewed, and on what the user wants to emphasize in the measure, e.g., a few large discrepancies vs. many small discrepancies.

FIG. 3C shows a non-limiting example of the resulting guiding matrix G, which is the outcome of step 2 of the method. In this figure, the distributions of the individual values of G matrices are shown, said distributions obtained for four different layers of the pre-trained learning model.

The network of the pre-trained model consists of four hidden layers; two of which have a reduced number of connections due to convolution—named convolution 1, convolution 2, and the other two which are fully connected—named fully connected 1, fully connected 2, the two latter layers forming connections from the outputs of all units in one layer to the inputs to all units in the other layer.

The Y axis indicates which proportion of all the parameters have assumed a given value, the X axis indicates the guidance values.

Interpretation of FIG. 3C: The values across the matrices G corresponding to the four different layers tend to be small, the majority being close to zero and only a few values exceeding 0.1. Such a distribution indicates that the matrix G of this example will strongly affect the training of the pre-trained model, by preventing most of the parameters from changing during the guided learning process in step 3.

The third step of the method, with reference to FIG. 1 and FIG. 2, has two sub-steps:

In the first sub-step of step 3, the second machine learning device receives simultaneously:
the guidance matrix and the pre-trained model from the first machine learning device, and,
the primary dataset;

The primary dataset—also called dataset 3 in FIG. 1 and FIG. 2, is received from an external datasets source and is outside the scope of the invention. The primary dataset and the dataset 2 must be selected so that they address related problems. See also plausibility below.

In the second sub-step of step 3, the second machine learning device guides the transfer learning of the pre-trained learning model on the main training problem by applying said guidance matrix to individually alter the process of updating the parameters of said artificial neural network while applying a gradient descent algorithm on the main training problem, and generates, at the end of the second sub-step of step 3, a trained model for making it available for use.

A non-limiting example of guidance is provided. Let us say that the guiding value for a weight w is g_{w}. Then, if the gradient descent algorithm computes a value of changing Aw, the guided change Δw_{g}, will be computed as:

$$Δ {w}_{g} = Δ w * {g}_{w} .$$

The same holds for changes in a bias, Δb:

$$Δ {b}_{g} = Δ b * gb .$$

This operation can be expressed in the matrix calculus as:

Δw_{g}=ΔwW G_{w}.
where G_{w} is the guidance matrix.

One non-limiting example of application of the guidance matrix into a deep learning code is provided below, see Code Illustration:

loss.backward( )
for name, param in model.named_parameters( ):
param.grad *= guidance_matrices[name]
optimizer.step( )

Code Illustration. In PyTorch, the application of the guiding matrix can be implemented by adding two lines of code between the backward computation of all deltas (loss.backward( ) and the application of those deltas (optimizer.step( ).

Thus, the outcome of the method of the invention, in all its preferred embodiments, is the trained model. The way the trained model is made available for use is outside the scope of the invention.

The method for guiding the transfer learning GTL of the invention, although sharing some features with the classical transfer learning and with the fine-tunning of prior art, has advantages in respect to both, as detailed below. For the ease of understanding it shall be considered that all three methods discussed start from the same pre-trained model with the same number of parameters.

A similarity of the GTL with the classical transfer learning is that both allow only for a subset of parameters to be changed, the difference being that the classical transfer learning allows the parameters in the specific layers to change—usually the added layers or the last layer, while the GTL picks the free-to-change parameters from within the entire pre-trained model. The fact that the scouting of the first step of GTL is carried out over the entire pre-trained model allows the selection from the entire pre-trained model of the parameters that will be trained during the step 3 makes the method of the invention similar to the fine-tuning, the difference being that the fine-tuning steps are not preceded by a process of selection of which parameters to train allowing all the parameters to change. The scouting carried out in step 1 of the method has—differently than the state of the art, the effect of a process of selection. This way, the method of the invention, combines the advantages of both transfer learning and fine-tuning due to the features of scouting process of step 1 and the generation of guidance values in step 2.

The advantage of the method for guiding the transfer learning GTL of the invention is that the number of parameters that change stays relatively low, enabling relatively smaller amounts of data to be used for training and a larger number of epochs to be applied without overfitting the training data, which is not the case for the fine-tuning, where easy overfitting of the training data remains a disadvantage, especially if the training dataset is small.

The disadvantage of the classical transfer learning in comparison to fine-tuning is that during the classical transfer learning, large parts of the pre-trained model remain unchanged although there is a strong need to make changes in order to improve the performance of the overall model i.e., the model gets stuck in the local minimum. As explained above, fine-tuning solves this problem but then creates a new problem by opening the possibility of an easy overfit of the training data if the amount of data points is too small.

The method for guiding the transfer learning GTL of the invention solves that conundrum by remedying the disadvantages of both methods of prior art i) by allowing changes in any part of the pre-trained model and ii) by allowing learning with small amounts of data points, avoiding both reaching the local minima, and overfitting the training data.

Effectively, the trained model becomes a sparse model during the training using the method for guiding the transfer learning GTL of the invention, with only a few parameters being allowed to change. Thus, the main learning problem is reduced to a smaller number of dimensions because a smaller number of parameters are allowed to change. Nevertheless, the computations of the network remain dense; it is only the training that becomes sparse.

In a second aspect of the invention, it is claimed a first machine learning device having at least one first processor, at least one first memory, and a first non-transitory computer-readable medium storing first computer-executable instructions.

The first machine learning device is communicatively coupled to a second machine learning device.

When said first computer-executable instructions are executed by the first machine learning device, the first machine learning device is configured to receive a pre-trained model, to carry out steps 1 and 2 of the method, generating a guidance matrix comprising guidance values, and to send the guidance matrix to the second machine learning device.

Non-limiting examples of the first machine learning device are the following: a processing unit, a computer, a super-computer, a network of computers, a server, a network of servers.

In a third aspect of the invention, it is claimed a second machine learning device having at least one second processor, at least second memory and a second non-transitory computer-readable medium storing second computer-executable instructions thereon.

The second machine learning device is communicatively coupled to the first machine learning device.

When said second computer-executable instructions are executed by the second machine learning device, the second machine learning device is configured to receive the pre-trained model and the guidance matrix comprising guidance values from the first machine learning device, and to carry out step 3 of the method, generating a trained model for making it available for use.

Non-limiting examples of the second machine learning device are the following: a processing unit, an electronic control unit, a computer, a super-computer, a network of computers, a server, a network of servers.

According to FIG. 1, in one preferred embodiment, the first machine learning device and, respectively the second machine learning device are different devices. Typical non-limiting arrangement for this embodiment: the first machine learning device is the computer/server of a manufacturing plant for vehicles, while the second machine learning device is an electronic control unit ECU of each vehicle. See also an example of the use of the method for guiding transfer learning of the invention below.

According to FIG. 2, in another preferred embodiment, the first machine learning device of claim 4 and the second machine learning device are physically and mechanically coupled.

Typical non-limiting arrangement for this embodiment: the machine learning device is a computer/super-computer/server of a research institute. See also plausibility below.

In a fourth aspect of the invention, it is claimed a guidance matrix comprising guidance values, generated by the first machine learning device, according to step 1 and 2 of the method of any of its embodiments.

Said guiding matrix—as an intermediary product—is used particularly when the first machine learning device and, respectively the second machine learning device are different devices. See also example of use of the method for guiding transfer learning of the invention below.

In a fifth aspect of the invention, it is claimed a trained model generated by the second machine learning device, according to step 3 of the method of any of its embodiments. The trained model is the output of the method for guiding transfer learning of the invention. See also the example of the use of the method for guiding transfer learning of the invention below.

In a sixth aspect of the invention, it is claimed a first non-transitory computer-readable medium storing thereon first computer-executable instructions which, when executed by the first machine learning device, cause the first machine learning device to carry out the steps 1 and 2 of the method of any of claims 1 to 3, and storing on the first non-transitory computer-readable medium the pre-trained learning model and the generated guidance matrix of claim 7.

In a seventh aspect of the invention, it is claimed a second non-transitory computer-readable medium storing thereon second computer-executable instructions which, when executed by the second machine learning device, cause the second machine learning device to carry out the step 3 of the method of any of the claims 1 to 3, and storing on the second non-transitory computer-readable medium the trained model of claim 8.

### Example of Use of the Method for Guiding Transfer Learning of the Invention

In an eighth aspect of the invention, it is claimed a method of use of the method for guiding transfer learning of any of its embodiments, suitable for the Advanced Driver Assistance Systems ADAS of a vehicle, wherein the second machine learning device is included in an Electronic Control Unit ECU of the vehicle, and wherein the trained model outputted by the second machine learning device is used to improve prediction of traffic events during driving as a form of continual adaptation [8].

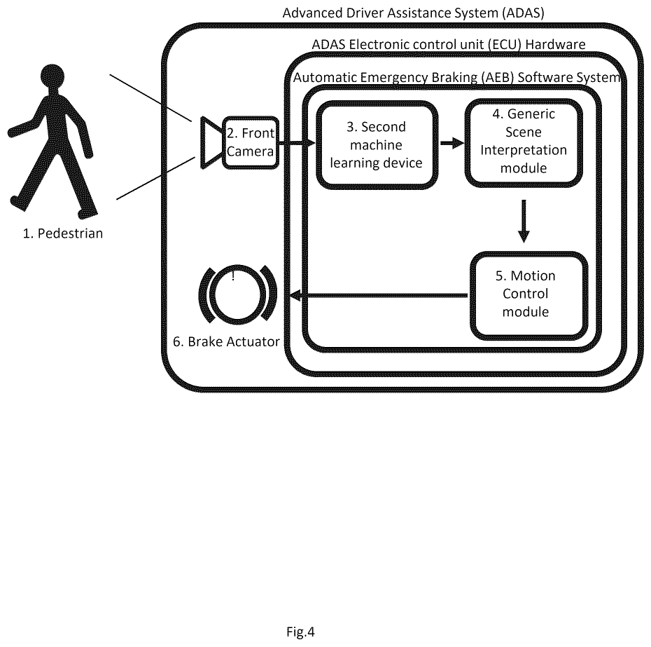

With reference to FIG. 4, in a non-limiting example of the method of use of the invention of the eighth aspect, the trained model of the invention is used in the automotive industry, in particular in the Advanced Driver Assistance Systems ADAS, whose objective is to assist driving-be it manned or autonomous, for the purpose of reducing the risk of accidents and/or injuries to the participants of the traffic. The ADAS components are based on sensing various parameters related to the traffic environment: atmospheric conditions, road conditions, presence of other vehicles, etc. Further on, various machine learning models embedded in the electronic control units ECU of the vehicles use the sensed data to make predictions of accidents and/or injuries, said predictions being further used to alert the driver and/or to apply automatic brakes. It is therefore very important that said various machine learning models have good performance of the prediction.

For the purpose of this example, one single function of ADAS was selected: Automatic Emergency Braking, as well as a single type of data to be sensed was selected: images from the front camera of the ego vehicle.

It shall be understood that the teaching of the invention is to be used mutatis mutandis to any other functions of ADAS and to all types of data to be sensed.

Thus, the parameters that are relevant in the invention refer to various visual conditions, such as but not limited to different grades of natural light: day, night, cloudy, sunny, while raining or snowing, shadows, tunnel, fog, etc.

In this non-limiting example, the first machine-learning device is the server or the computer of the manufacturing plant where the vehicles are manufactured. The weights w_{Pj} and biases b_{Po}, of the pre-trained model refer to said various visual conditions. Dataset 1 for training the pre-trained model comprises general data with respect to the grades of the natural light irrespective of the lighting conditions. The dataset 2 used in the first step of the method for training of the scout networks K comprises more images from the Nordic regions of Europe and America. The guidance matrices G are calculated by the first machine learning device located at the manufacturing plant, stored on the first non-transitory computer-readable medium, and then sent to the second machine learning device 3 together with the pre-trained model.

Each vehicle has his own front camera 2, which senses images and transmits the sensed images to the AEB Software system. Said AEB Software system comprises the second machine learning device 3, a generic scene interpretation module 4 and a motion control module 5, said motion control 5 being in communication with a brake actuator 6.

The second machine learning device 3 continuously and repeatedly applies step 3 of the method for guiding transfer learning of the invention—in any of the method embodiments, in order to enable the generic scene interpretation module 4 to adjust itself to the ever-changing visual conditions. This is made by the method of auto-encoding. The guidance matrices G realize the transfer learning of the pre-trained learning model on the main training problem is carried out by applying said guidance matrices to individually alter the process of updating the parameters of the artificial neural network in order to maximize its auto-encoding performance based on the images sensed by the front camera 2, which constitute in this case the primary dataset. The trained model is continuously created and stored on the second non-transitory computer-readable medium.

Thanks to using the method of the invention, the trained model does not overfit the training data and does not get stuck in local minima, which allows a better prediction by the motion control module 5. A pedestrian walking in front of the vehicle in a very poor light situation: a combination of fog, rain and night for example, has better chances to be detected by the pre-trained model additionally adjusted with guided transfer learning than either by a non-adjusted pre-trained model or pre-trained model adjusted by traditional fine-tuning, as the motion control module 5 receives better prediction to send an emergency brake instruction to the brake actuator 6, saving the pedestrian's life.

Plausibility. Another Example of Use of the Method of Guiding Transfer Learning

The inventors tested the teaching of the invention after the filing date of the Provisional US Application in a research project carried out by a larger team of researchers from five institutions. The team of researchers—which includes the inventors of this application, published the results in an article submitted on 17 Nov. 2023 [5].

The research project addressed the field of omics data, in particular RNA-seq data which, as the researchers state, “is characterized by high dimensionality and low sample size (HDLSS)”. The main problem of prior art techniques is that “current attempts [=prior art] at integrating AI in this domain require significant human guidance and expertise to mitigate overfitting”- and that “previous attempts have shown traditional transfer learning failing on HLDSS”. Thus, in this example, overfitting of the training data was the main disadvantage of prior art techniques.

Consequently, the method of the invention—the guided transfer learning GTL was used “by pre-training on a general task with a large aggregate of data, then fine-tuning to various specific, downstream target tasks in the same domain”.

In this example, the first machine learning device and the second machine learning device are physically and mechanically coupled as shown in FIG. 2.

The researchers used an artificial neural network with an scBERT architecture which is a transformer-based encoder architecture built off BERT.

The goal of the research project was to create a trained model—called in the article “AI agent”, “that is an expert in RNA-seq data, such that it would be able to learn any downstream task involving RNA-seq data even when the training sample size is extremely low.”

Phase 1 of the research project corresponds to step 1 of the invention. During the scouting, the scouts of the model architecture were trained on subproblems—partitions of a full dataset that corresponds to dataset 1 of the invention: the accurate classification of a gene expression profile to a given cluster that is prediction to the cluster identity of samples. FIG. 1 of the article shows that in the first phase, “the entire encoder-reconstructor architecture of scBERT is pre-trained in a self-supervised manner and initial weights are learned”.

Phase 2 of the research project corresponds to step 2 of the method. As shown in FIG. 1 of the article, in the second phase, “the entire encoder-reconstructor architecture of scBERT is used during the scouting procedure, and guide [=guidance] values for the weights are learned.” During their convergence, corresponding to the scouting process in step 1 of the method, the scouts kept track of how much each weight in the architecture changes, and this information was averaged across scouts to determine the guidance values for each weight in the main copy of the model. The objective of steps 1 and 2 was “to have the scBERT model learn how to learn more efficiently from RNA-seq data during new, downstream tasks and this knowledge/intuition would be stored in the guide [=guidance] values of the weights in the encoding portion of the scBERT architecture”. Here, dataset 2 was created from dataset 1, whereby the problems for scouts were made to have low difficulty by selecting subsets of data based on principal component analysis.

In Phase 3—corresponding to step 3 of the method, the same model architecture was used as the one in Phase 2, having as input both pre-trained weights and inductive biases in the form of guide [=guidance] values. The primary dataset used in this phase was “NASA OSD-105, a small dataset from the NASA Open Science Data Repository OSDR consisting of RNA-seq data taken from the tibialis anterior muscle of 6 space flown (FLT) and 6 ground control (GC) mice. The model task was to predict whether a mouse was FLT or GC.” The problems of datasets are related because they all pertain to mice RNA.

As seen in FIG. 1 of the article, in the third phase “the encoder portion of the [scBERT] architecture is attached to a fully-connected prediction layer that outputs a label. This architecture is then trained on the downstream supervised task.”

The researchers used then two similar datasets as respectively, validation and test sets, namely “RNA-seq from mouse soleus muscle in OSD-104 and RNA-seq from mouse extensor digitorum longus muscle OSD-99, respectively”.

In the research project, three separate models were trained “to evaluate the improvement offered by conventional pre-training and scouting methodologies for few-shot learning tasks”:
1) a first model that did not undergo any pretraining at all (randomly initiated parameters)”, thus without any training.
2) a second model that only underwent conventional pre-training on the full dataset, thus all the training was carried out according to prior art.
3) a model that underwent the full GTL pipeline, with both conventional pre-training on the full dataset and scouting on sub-clusters of the dataset, thus the method of the invention was applied.

The comparative analysis of the results of the three models described above: the first without training, the second according to prior art, and the third having all the steps of the method applied, shows as follows [pages 15-16 of the article]:
On the validation set:
the first model: “the model with no pre-training at all started overfitting the training set almost immediately, as indicated by the validation loss beginning to increase from the very beginning while the training loss kept decreasing”—see FIG. 7a of the article;
the second model: “before overfitting started occurring, there was a sweet spot at around 200 epochs where the validation loss was at a low and the validation accuracy was at a high of 91%—see FIG. 7b of the article;
the third model: “a similar effect with the model that underwent both conventional pre-training and scouting, but the maximum validation accuracy was higher at 100%, and this maximum validation accuracy was maintained for more epochs before overfitting started occurring
see FIG. 7c of the article.
On the test set—see Table of the article on page 16:
for the first model: the test accuracy was at the chance level, 50%,
for the second and the third model: the test accuracy was 83%.

The results of the research project also show how and when the local minimum is avoided: “the validation curves for the scouted model were slightly noisier overall throughout the course of fine-tuning[=step 3 of the method]. This is likely a result of the cosine annealed warm restarts learning rate scheduler, which cycles through learning rates to “jump out of” local minima, so the jumps in validation accuracy and loss in the beginning are likely points where the model escapes a local minimum.”

To conclude, the results of the research project show that the method for guiding transfer learning according to the invention allows learning with small amounts of datapoints, avoiding both overfitting avoiding both reaching the local minima, and overfitting the training data.

While the description of the invention was disclosed in detail in connection to preferred embodiments, those skilled in the art will appreciate that changes may be made to adapt a particular situation without departing from the essential scope to the teaching of the invention.

### END NOTES—BIBLIOGRAPHICAL REFERENCES

[1] LeCun, Yann, et al. “Gradient-based learning applied to document recognition.” Proceedings of the IEEE 86.11 (1998): 2278-2324.

[2] Kaplan, Jared, et al. “Scaling laws for neural language models.” arXiv preprint arXiv:2001.08361 (2020).

[3] Hoffmann, J., Borgeaud, S., Mensch, A., Buchatskaya, E., Cai, T., Rutherford, E., . . . & Sifre, L. (2022). Training Compute-Optimal Large Language Models. arXiv preprint arXiv:2203.15556.

[4] Nikolić, D. (2022). Building Great Artificial Intelligence. The Handbook of Data Science and AI: Generate Value from Data with Machine Learning and Data Analytics, 239.

[5] Kevin Li, Danko Nikolić, Vjekoslav Nikolić, Davor Andrić, Lauren M. Sanders, Sylvain V. Costes (2023). Using Guided Transfer Learning to Predispose AI Agent to Learn Efficiently from Small RNA-sequencing Datasets https://arxiv.org/abs/2311.12045_submitted_17 November 2023, published 23 Nov. 2023.

[6] Linial, N., Mansour, Y, & Nisan, N. (1993). Constant depth circuits, Fourier transform, and learnability. Journal of the ACM (JACM), 40(3), 607-620.

[7] Mansour, Y (1994). Learning Boolean functions via the Fourier transform. In Theoretical advances in neural computation and learning (pp. 391-424). Springer, Boston, MA.

[8] Zhou, Shiji, Han Zhao, Shanghang Zhang, Lianzhe Wang, Heng Chang, Zhi Wang, and Wenwu Zhu. “Online continual adaptation with active self-training.” In International Conference on Artificial Intelligence and Statistics, pp. 8852-8883. PMLR, 2022.

What is claimed is:

1. A method for guiding transfer learning carried on a pre-trained learning model to be trained on a primary dataset to solve a main training problem, the main training problem having a main training problem difficulty d(main), the pre-trained learning model being an artificial neural network having a plurality of parameters, namely weights w_{Pj} and biases b_{Po}, the method comprising the following steps:
S1 receiving the pre-trained learning model by a first machine learning device;
creating a plurality of scout networks K from the artificial neural network, each scout network k having its plurality of parameters—weights wⱼₖ and biases bₒₖ;
wherein for each parameter (w_{Pj}, b_{Po}) in the pre-trained learning model, there is a corresponding parameter (wⱼₖ, bₒₖ) in each scout network k;
assigning to each corresponding parameter (wⱼₖ, bₒₖ) of each scout network k a corresponding scout training problem, each scout training problem having a corresponding scout training problem difficulty dₖ(scout), where each scout training problem difficulty dₖ(scout) is much lesser than the main training problem difficulty d(main):
dₖ(scout)<<d(main)
wherein
the main training problem difficulty d(main) and each scout training problem difficulty dₖ(scout) is measured in terms of error rate and/or loss on a test dataset, said measures being reached after training of the pre-trained learning model,
S2 generating, by the first machine learning device, a guidance matrix comprising guidance values, where the guidance values are calculated based on one measure of central tendency of differences between every weight wⱼₖ and bias bₒₖ of the plurality of scout networks k, and the corresponding weight w_{Pj} and bias b_{P0} of the pre-trained learning model, respectively, and sending the guidance matrix to a second machine learning device together with the pre-trained model;
S3 receiving by the second machine learning device of the guidance matrix and of pre-trained model from the first machine learning device and, simultaneously, receiving the primary dataset;
guiding, by the second machine learning device, the transfer learning of the pre-trained learning model on the main training problem by applying said guidance matrix to individually alter the process of updating the parameters of said artificial neural network while applying a gradient descent algorithm on the main training problem; and
generating a trained model for making it available for use.

2. The method for guiding transfer learning of claim 1, wherein the main training problem difficulty d(main) is expressed as a number of n(main) training categories of the main training problem, and scout problem training difficulty is expressed as a number of nₖ(scout) training categories of the corresponding scout training problem, where the number of training categories of each scout problem nₖ(scout) is much lesser than the number of training categories of the main training problem n(main):
nₖ(scout)<<n(main)

3. The method for guiding transfer learning of claim 1, wherein the calculation of the central tendency of step S2 is based on one measure of central tendency selected from the list below:
the mean of squared differences across the weights wⱼₖ and biases bₒₖ, and w_{Pj}, b_{Po} respectively,
the mean absolute values of differences across the weights wⱼₖ and biases bₒₖ, and w_{Pj}, b_{Po} respectively,
the median value of the squared differences or the absolute values of differences across the weights wⱼₖ and biases bₒₖ, and w_{Pj}, b_{Po} respectively, and
the mode value for the squared differences or the absolute values of differences across the weights wⱼₖ and biases bₒₖ, and w_{Pj}, b_{Po} respectively.

4. A system comprising:
a first machine learning device having at least one first processor, at least one first memory, and a first non-transitory computer-readable medium storing first computer-executable instructions thereon;
the first machine learning device communicatively coupled to a second machine learning device;
wherein when said first computer-executable instructions are executed by the first machine learning device, the first machine-learning device is configured:
to receive a pre-trained model,
to carry out steps S1 and S2 of the method of claim 1, generating a guidance matrix comprising guidance values, and
to send the guidance matrix to the second machine-learning device.

5. The system of claim 4, further comprising:
a second machine learning device having at least one second processor, at least second memory and a second non-transitory computer-readable medium storing second computer-executable instructions thereon,
the second machine learning device communicatively coupled to the first machine learning device;
wherein when said second computer-executable instructions are executed by the second machine learning device, the second machine learning device is configured:
to receive the pre-trained model and the guidance matrix comprising guidance values from the first machine learning device, and
to carry out step S3 of the method of claim 1, generating a trained model for making it available for use.

6. The system of claim 4, wherein the first machine learning device and the second machine learning device are physically and mechanically coupled.

7. The system of claim 4, further comprising a guidance matrix having guidance values, generated by the first machine learning device.

8. The system of claim 7, further comprising a first non-transitory computer-readable medium storing thereon first computer-executable instructions which, when executed by the first machine learning device, cause the first machine learning device to carry out the steps S1 and S2 and to store on the first non-transitory computer-readable medium the pre-trained learning model and the guidance matrix.

9. The system of claim 4, further comprising a trained model generated by the second machine learning device.

10. The system of claim 8, further comprising a second non-transitory computer-readable medium storing thereon second computer-executable instructions which, when executed by the second machine learning device, cause the second machine learning device to carry out step S3 and store on the second non-transitory computer-readable medium the trained model.

11. The system of claim 8, wherein the second machine learning device is included in an Electronic Control Unit ECU for an Advanced Driver Assistance Systems ADAS of a vehicle, and wherein the trained model outputted by the second machine learning device is used to improve prediction of traffic events during driving.
